(19) United States
(12) Patent Application Publication
(10) Pub. No.: US 2018/0131033 A1
(43) Pub. Date: May 10, 2018

(54) BATTERY MODULE, COVER ELEMENT OF A BATTERY MODULE, METHOD FOR MANUFACTURING SAME AND BATTERY

(71) Applicant: Robert Bosch GmbH, Stuttgart (DE)

(72) Inventors: Matthias Oechsle, Ditzingen-Hirschlanden (DE); Ronny Wolf, Eisenach (DE); Thomas Dittert, Stuttgart (DE); Torsten Friesse, lngersleben (US)

(21) Appl. No.: 15/807,886

(22) Filed: Nov. 9, 2017

(30) Foreign Application Priority Data
Nov. 10, 2016 (DE) 10 2016 222 083.7

(51) Int. Cl. H01M 10/05; H01M 2/04; H01M 2/10; H01M 2/20; H01M 10/04

(52) U.S. Cl. CPC H01M 10/05; H01M 2/04; H01M 10/04; H01M 2/20; H01M 2/1016

(57) ABSTRACT

A battery module having battery cells (2), a cell connector (4) electrically connecting two battery cells (2), a signal line connection (5) connectable to a monitoring unit, and an electrically conductive connecting element (6) that has a first layer (61), formed from a first material, with a first surface (71) and a second surface (72), and a second layer (62), formed from a second material different than the first material, with a first surface (81) and a second surface (82), wherein the second surface (72) and the further second surface (2) are directly connected to one another and the first surface (81) is connected to the signal line connection (5), and a conductor track (9) formed from the first material is connected to the cell connector (4) or to the first voltage tap (3) and is also connected to the first surface (71) of the connecting element (61).

### BACKGROUND OF THE INVENTION

The invention sets out from a battery module or a cover element of a battery module. In addition, the invention also relates to a method for manufacturing a battery module or a cover element for a battery module. The subject matter of the present invention is also a battery.

The prior art discloses that a battery, such as a lithium ion battery, can have a battery module or, as a preference, also a plurality of battery modules. In this case, a battery module has a plurality of battery cells that respectively have a positive voltage tap and a negative voltage tap. Connecting elements referred to as cell connectors are used for electrically interconnecting the voltage taps of the plurality of battery cells in series or in parallel. Usually, the voltage taps and also the cell connector are formed from aluminum, for example.

For monitoring the operation of the individual battery cells, it is known practice to connect them to a monitoring unit. To this end, measuring lines can form an electrically conductive connection between the monitoring unit and the cell connector or between the monitoring unit and one of the two voltage taps of a battery cell. Usually, electronic components of the monitoring unit and the measuring lines are formed from copper, for example, in this case and also arranged on what is known as a printed circuit board with conductor tracks made of copper.

When manufacturing the monitoring from a single battery cell, the aforementioned configurations therefore require a material transition to be formed between copper and aluminum, said material transition possibly being subject to corrosion during operation and therefore frequently needing to be afforded separate protection.

The document DE 10 2012 218 500 A1 discloses an apparatus for connecting multiple electrical energy stores to form a battery by means of multiple electrically conductive contact elements of the apparatus. In this case, the contact elements are fixed in a common support made of an electrically insulating support material. In addition, at least one of the contact elements is connected to at least one conductor track, the contact elements and the at least one conductor track being punched out from a single piece of sheet metal as punched parts.

The document EP 2 639 857 A1 discloses a connecting system for an energy storage device having a plurality of cells and having a plurality of cell connectors, held by a support system, for electrically interconnecting the cells. The support system has a storage control unit formed in it for monitoring the energy reserve and/or state of charge of the cells.

### SUMMARY OF THE INVENTION

The battery module and cover element the of a battery module and also the methods for manufacturing same according to the invention have the advantage that a simple and reliable connection can be formed between a signal line connection, which is connectable to a monitoring unit of the battery module, and a cell connector or a voltage tap of a battery cell, which allows reliable monitoring of the operation of one of the battery cells.

According to the invention, a battery module having a plurality of battery cells is first of all provided. The battery cells respectively have a first voltage tap and a second voltage tap. In this case, a cell connector electrically connects two battery cells in series or in parallel with one another. Moreover, the battery module has a signal line connection that is connectable to a monitoring unit of the battery module. In addition, the battery module has an electrically conductive connecting element that has a first layer and a second layer. In this case, the first layer is formed from a first material and the second layer is formed from a second material, which is different than the first material. The first layer has a first surface and a further first surface. These surfaces can also be referred to as the first and second surfaces of the first layer. The second layer has a second surface and a further second surface. These surfaces can also be referred to as the first and second surfaces of the second layer. In this case, the further first surface of the first layer and the further second surface of the second layer are electrically conductively and directly connected to one another. Furthermore, the second surface of the second layer is electrically conductively connected to the signal line connection. Further, the battery module has an electrically conductive conductor track that is formed from the first material.

In this case, the electrically conductive conductor track is electrically conductively connected to the cell connector or the first voltage tap and also electrically conductively connected to the first surface of the connecting element.

Hence, the signal line connection, which is connectable to a monitoring unit of the battery module, and the cell connector or the first voltage tap are electrically conductively connected to one another by means of the electrically conductive connecting element and the electrically conductive conductor track in order to be able to monitor the operation of the battery cells.

In particular, the electrically conductive conductor track may be in the form of a cable that may additionally also have an electrically insulating coating. In addition, the electrically conductive conductor track may particularly also be what is known as a flexible flat cable (FFC), which comprises a plurality of electrical conductor tracks arranged on a film made of plastic, or what is known as a lead frame, which comprises a plurality of metal structures. In this case, the electrically conductive conductor track is not intended to be restricted to the examples mentioned here, however, but rather is intended to comprise any element that can be used for producing an electrically conductive connection.

The signal line connection, which is connectable to a monitoring unit of the battery module, may, to this end, be electrically conductively connected to a connector or plug contact, for example, the connector or plug contact being connectable to the monitoring unit of the battery module. In addition, the signal line connection may naturally also be the signal line connection of the monitoring unit and hence may already be connected to the monitoring unit.

A monitoring unit is intended to be understood to mean a control and/or regulatory unit of the battery module that monitors and controls a temperature or voltage of the battery cell, for example.

In this case, it is expedient if the first voltage tap and/or the cell connector are also formed from the first material. As a result, a reliable connection can be formed between the first voltage tap or the cell connector and the electrically conductive conductor track, since identical materials are connected to one another, so that, particularly in a simple manner, a connection by means of a material bond, for example by means of welding, is possible.

In addition, it is also expedient in this case if the signal line connection is formed from a third material, which is different than the first material, that is preferably connectable to the second material, from which the second layer is formed, in a simple manner.

Overall, such a development affords the advantage that a transition from the material from which the voltage tap and the cell connector are formed to the material from which the electronic components of the monitoring unit or the signal line connections thereof are formed, which transition needs to be formed when an electrically conductive connection is formed between the first voltage tap or the cell connector and the monitoring unit, is formed by the electrically conductive connecting element.

Hence, the requisite material transition can be formed in a separate manufacturing process during the manufacture of the electrically conductive connecting element, as a result of which the material transition does not need to be formed during final installation of the assembly, and hence the manufacturing process as a whole has a higher level of reliability and certainty.

As a result, the requisite material transition is formed only on the electrically conductive connecting element and can also easily be afforded separate protection at this location, separate protective measures not being absolutely necessary at the other connecting points, for example between the electrically conductive conductor track and the cell connector, which is now a connection in the same material.

As a particular preference, the first material in this case is aluminum, as a result of which the first layer of the electrically conductive connecting element, the electrically conductive conductor track and particularly the cell connector or the first voltage tap are formed from aluminum. In addition, at this juncture, this is also intended to be understood to mean that the first material comprises aluminum and, by way of example, has a volume proportion of aluminum greater than 50% and preferably greater than 80%.

To monitor the operation of the battery cells, the electrically conductive conductor track is first of all electrically conductively connected to the first surface of the first layer of the electrically conductive connecting element, the configuration in the same material particularly allowing a simple connection. In this case, this connection is preferably formed by a material bond, such as by welding, resistance welding, ultrasonic welding or laser welding, for example, in order to form a reliable electrical line.

In addition, to monitor the operation of the battery cell, the electrically conductive conductor track is electrically conductively connected to the first voltage tap or the cell connector, a simple connection being possible particularly on account of the configuration in the same material. In this case, this connection is preferably formed by a material bond, such as by welding, resistance welding, ultrasonic welding or laser welding, for example, in order to form a reliable electrical line.

Particularly such connections formed by material bond can be implemented reliably and also in a defined manner.

In addition, electrically conductive conductor tracks formed from aluminum or comprising aluminum have the advantage of lower weight and lower material price in comparison with electrically conductive conductor tracks formed from copper.

In addition, it is also particularly preferred if the second material is copper and that, in addition, the third material is also copper, as a result of which the second layer and the signal line connection are formed from copper. In addition, at this juncture this should also be understood as meaning that the second material and/or the third material comprise copper and, by way of example, have a volume proportion of copper greater than 50% and preferably greater than 80%. To monitor the operation of the battery cell, the second layer of the electrically conductive connecting element is electrically conductively connected to the signal line connection, a simple connection being possible particularly on account of the configuration in the same material. In this case, this connection is preferably formed by a material bond, such as by welding, for example, so as to form a reliable electrical line in this case too. By way of example, an electrically conductive connecting element that has a first layer formed from aluminum and a second layer formed from copper may be formed by means of a roll-bonding process as what is known as clad material.

According to an additionally particularly preferred embodiment, the second material is nickel and also the third material is copper. In addition, at this juncture this is also intended to be understood to mean that the second material comprises nickel and, by way of example, has a volume proportion of nickel greater than 50% and preferably greater than 80%. In addition, at this juncture this is also intended to be understood to mean that the third material comprises copper and, by way of example, has a volume proportion of copper of greater than 50% and preferably greater than 80%. In this case, the second surface is connected to the signal line connection by a material bond, such a connection being able to be formed particularly by soldering.

By way of example, an electrically conductive connecting element that has a first layer formed from aluminum and a second layer formed from nickel may be formed by means of application of an electroplated coating of nickel onto aluminum. Such a configuration allows a simple demonstration of the solder process.

It is expedient if the battery module also has a water-repellent protective layer that may moreover also be electrically insulating. The protective layer is in this case arranged circumferentially on the connection region between the first layer and the second layer, which connection region is formed via the connection of the further first surface and the further second surface, toward the surroundings and covers the connection region from the surroundings at least in part and preferably completely. This has the advantage that the material transition between the materials of the first layer and the second layer, particularly between aluminum and copper or between aluminum and nickel, which material transition is particularly susceptible to corrosion, can be protected in a simple manner and efficiently, since the material transition on the electrically conductive connecting element has a geometrically defined structure. As a result, solutions known from the prior art, which are often complex to demonstrate, such as coating the entire monitoring unit, along with signal line connections, with a lacquer or the coating of the connecting point between the electrically conductive conductor track and the cell connector or the first voltage tap with a lacquer, for example, can be dispensed with.

It is advantageous if the solder used for forming a connection by a material bond also forms the protective layer, which further simplifies the process.

In particular, the signal line connection that is electrically conductively connectable to a monitoring unit of the battery module is arranged on a printed circuit board of the battery module. At this juncture, a printed circuit board is intended to be understood to mean an element of a battery module that can comprise the electronic elements of the battery module, such as control and regulatory units, for example, and also electrical conductor tracks.

As a preference, the printed circuit board with the signal line connection arranged thereon also has a protective layer that may, in particular, be water-repellant and electrically insulating and that can at least partially cover the electronic components, the electrical components and particularly also the connecting element connected to the signal line connection from the surroundings, and, as a preference, covers them from the surroundings, in order to protect the aforementioned components from moisture and particles.

The protective layer arranged circumferentially on the connection region may in this case thus also be in the form of a part of the entire protective layer of the printed circuit board, for example, so that a simpler configuration in comparison with embodiments known from the prior art is possible in the case of such an embodiment according to the invention, since separate protection of the material transition is dispensed with, which material transition, in the prior art, is frequently formed between the cell connector made of aluminum and the electrically conductive conductor track made of copper and hence then calls for a separate protective layer as well.

In this case, it is firstly possible for the protective layer of the entire printed circuit board, along with the protective layer of the circumferential connection region, to be formed after the formation of the electrically conductive connection between the electrically conductive conductor track and the first surface of the first layer or, secondly, for the protective layer of the entire printed circuit board, together with the protective layer of the circumferential connection region, to be performed before the formation of the electrically conductive connection between the electrically conductive conductor track and the first surface of the first layer, wherein, in this other case, at least the first surface of the first layer protrudes from the protective layer in order to form the connection.

A protective layer according to the invention does not allow moisture that gets into the battery module or that is present in the battery module to get to the connecting point between the first layer and the second layer and hence to result in contact corrosion.

According to the invention, a cover element of a battery module having a plurality of battery cells is also provided. In this case, the cover element has a cell connector that is configured for electrically connecting two battery cells of the battery module, particularly the voltage taps of two battery cells, in series or in parallel with one another. In particular, the cell connector is formed from a first material. In addition, the cover element has a signal line connection that is connectable to a monitoring unit of the battery module. In particular, the signal line connection is formed from a third material, which is different than the first material.

In addition, the cover element has an electrically conductive connecting element that has a first layer and a second layer. In this case, the first layer is formed from the first material and the second layer is formed from a second material, which is different than the first material. The first layer has a first surface and a further first surface. The second layer has a second surface and a further second surface. In this case, the further first surface of the first layer and the further second surface of the second layer are electrically conductively and directly connected to one another. Furthermore, the second surface of the second layer is electrically conductively connected to the signal line connection. Further, the battery module has an electrically conductive conductor track that is formed from the first material. In this case, the electrically conductive conductor track is electrically conductively connected to the cell connector or the first voltage tap and also electrically conductively connected to the first surface of the connecting element. Hence, the signal line connection, which is connectable to a monitoring unit of the battery module, and the cell connector are electrically conductively connected to one another by means of the electrically conductive connecting element and the electrically conductive conductor track in order to be able to monitor the operation of the battery cells.

The cover element according to the invention for a battery module, which has just been described, can also advantageously and expediently be developed by all the developments mentioned and illustrated in connection with the battery module according to the invention, so that a listing and further detailed description is dispensed with at this juncture.

Further, the invention also relates to a method for manufacturing a battery module according to the invention or a cover element according to the invention. In this case, a cell connector that is configured for connecting a first voltage tap and a second voltage tap in series or in parallel is provided in a first step. In particular, the cell connector and the first voltage tap are formed from a first material in this case.

In addition, the first step involves a signal line connection that is connectable to a monitoring unit of the battery module being provided in this case, wherein the signal line connection is formed particularly from a third material, which is different than the first material.

Furthermore, the first step also involves an electrically conductive connecting element being provided that has a first layer formed from the first material and a second layer formed from a second material, which is different than the first material. The first layer has a first surface and a further first surface and the second layer has a second surface and a further second surface. In this case, the further first surface and the further second surface are electrically conductively and directly connected to one another.

Subsequently, a second step involves the second surface being electrically conductively connected to the signal line connection.

In addition, a third step then involves an electrically conductive conductor track formed from the first material being electrically conductively connected to the cell connector. Furthermore, the third step involves the electrically conductive conductor track formed from the first material being electrically conductively connected to the first surface of the connecting element.

The method according to the invention for manufacturing a battery module according to the invention or a cover element according to the invention for a battery module can naturally also be developed by the illustrated advantages and developments.

In particular, the first step may also comprise the formation of the electrically conductive connecting element. In this case, the first layer and the second layer are first of all provided and subsequently a roll-bonding process is used to electrically conductively and also directly connect the further first surface and the further second surface to one another. This allows simple manufacture of the electrically conductive connecting element, the requisite material transition being able to be formed in this method step, as already described further above. In addition, it is also possible for the electrically conductive connecting element to be formed by the application of an electroplated coating.

In addition, it is particularly also possible for the signal line connection to be arranged on a provided printed circuit board of the battery module in the first step. Before the third step is performed or after the third step is performed, a protective layer can be arranged on the printed circuit board such that at least the connection region between the first layer and the second layer, which connection region is formed circumferentially a connecting element and is formed on account of the connection between the further first surface and the further second surface, is covered from the surroundings.

In addition, it is possible for the third method step to involve the electrically conductive conductor track being connected to the cell connector or the first voltage tap by a material bond, particularly by welding, and also being connected to the first surface of the electrically conductive connecting element by a material bond, particularly by welding. As a result, a reliable electrically conductive connection can be formed.

It is also possible for the second step also to involve the second surface of the electrically conductive connecting element being connected to the signal line connection by a material bond, particularly by welding or soldering.

Further, the invention also relates to a battery having a battery module according to the invention or having a cover element according to the invention for a battery module, wherein the battery module or the cover element of a battery module is manufactured particularly using a method according to the invention.

### BRIEF DESCRIPTION OF THE DRAWINGS

Exemplary embodiments of the invention are depicted in the drawings and explained in more detail in the description below.

FIG. 1 schematically shows a side view of an embodiment of a battery module according to the invention, and

FIG. 2 schematically shows a sectional view of a detail from a battery module according to the invention with a connecting element from the side and in a plan view.

FIG. 3 schematically shows two battery cells of the battery module.

### DETAILED DESCRIPTION

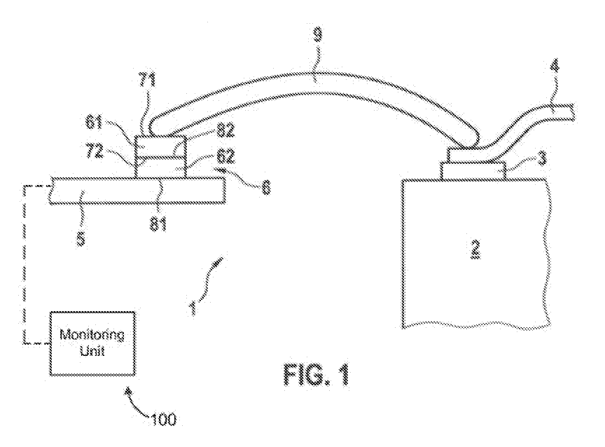

FIG. 1 schematically shows a side view of an embodiment of a battery module 1 according to the invention.

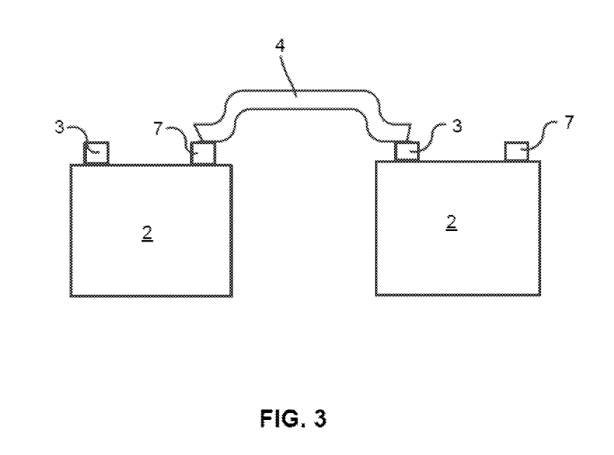

Such a battery module 1 preferably has a plurality of battery cells 2, only one battery cell 2 of which is shown by way of example in FIG. 1, however. As shown in FIG. 3, the battery cells 2 respectively have a first voltage tap 3, particularly a positive voltage tap, and a second voltage tap 7, particularly a negative voltage tap. As a preference, the first voltage tap 3 is formed from a first material in this case.

In addition, FIG. 3 shows that the battery module 1 has a cell connector 4 that is electrically conductively connected to the first voltage tap 3 of one battery cell 2 shown and is also electrically conductively connected to a first voltage tap 3 or a second voltage tap 7 of a second battery cell 2 of the battery module 1 (the cell connector 4 is connected to the voltage tap 7 of the second battery cell 2 in FIG. 3). As a result, the cell connector 4 electrically connects two battery cells 2 in series or in parallel with one another. As a preference, such a cell connector 4 is formed from the first material.

The battery module 1 also has a signal line connection 5 that is connectable or connected to a monitoring unit 100—shown schematically in FIG. 1—of the battery module 1. As a preference, such a signal line connection 5 is formed from a third material, which is different than the first material.

The battery module 1 has an electrically conductive connecting element 6. The electrically conductive connecting element 6 has a first layer 61 and a second layer 62. In this case, the first layer 61 has a first surface 71 and a second surface 72. In addition, the second layer 62 has a first surface 81 and a second surface 82 in this case. The first layer 61 is formed from the first material and the second layer 62 is formed from a second material, which is different than the first material.

Further, FIG. 1 also shows that the second surface 72 and the second surface 82 are electrically conductively and also directly connected to one another.

In this case, the first surface 81 is electrically conductively connected to the signal line connection 5. As a particular preference, the second material of the second layer 62 is copper and the third material of the signal line connection 5 is also copper in this case, so that a reliable connection in the same material can be formed in this case. In particular, this connection can be formed by a material bond, a welded configuration being preferred.

Alternatively, the second material of the second layer 62 may also be nickel and also the third material of the signal line connection 5 may be copper, so that in this case too a reliable connection can be formed, in particular this connection can be formed by a material bond, a soldered configuration for the connection being preferred.

Further, the battery module 1 has an electrically conductive conductor track 9 formed from the first material. In this case, the electrically conductive conductor track 9 is firstly electrically conductively connected to the first surface 71 of the first layer 61 and secondly electrically conductively connected to the cell connector 4. At this juncture, it should be noted that the electrically conductive conductor track 9 may, instead of being electrically conductively connected to the cell connector 4 as shown in FIG. 1, also be electrically conductively connected to the first voltage tap 3.

As already mentioned, the cell connector 4 and the first voltage tap 3 are also formed from the first material, so that the electrically conductive connection shown between the electrically conductive conductor track 9 and the first surface 71 of the first layer 61 and the electrically conductive connection shown between the electrically conductive conductor track 9 and the cell connector 4 or also the electrically conductive connection, not shown in this case, between the electrically conductive conductor track 9 and the first voltage tap 3 can be formed reliably, in electrically conductive form, as a connection in the same material. Particularly if the first material is advantageously aluminum, reliable formation of the connection just mentioned by a material bond is possible, said connection being able to be formed particularly by welding, such as by ultrasonic welding, for example.

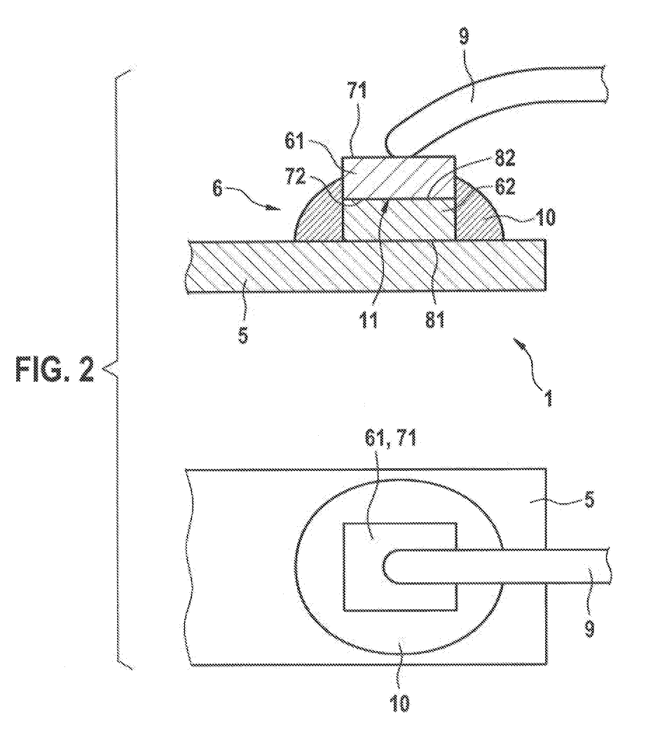

The top depiction in FIG. 2 schematically shows a sectional view from the side, and the bottom depiction shows a plan view, of a detail from a battery module 1 according to the invention with a connecting element 6.

The depiction of a battery module 1 according to the invention as shown in FIG. 2 differs from the battery module 1 depicted in FIG. 1 by virtue of the arrangement of a protective layer 10.

The protective layer 10 is in this case formed from a water-repellent material, which may also be electrically insulating.

During the formation of the electrically conductive and direct connection between the second surface 72 and the second surface 82, a connection region 11 arranged circumferentially on the connecting element 6 is formed. In this case, the protective layer 10 covers this connection region 11 between the first layer 61 and the second layer 62 from the surroundings. In this case, the top depiction shown in FIG. 2 particularly reveals that the protective layer 10 covers the connection region 11 from the surroundings and the bottom depiction shown in FIG. 2 reveals that the protective layer 10 is arranged circumferentially on the connecting element 6.

For a connection in soldered form between the first surface 81 and the signal line connection 5, the solder material used in this case can also form the protective layer 10.

At this juncture, it should also be noted that the battery module 1 described is depicted merely schematically.

1. A battery module having a plurality of battery cells (2) that respectively have a first voltage tap (3) and a second voltage tap (7),
wherein a cell connector (4) electrically connects two of the plurality of battery cells (2) in series or parallel with one another, and the battery module (1) has a signal line connection (5) configured to be connected to a monitoring unit (100) of the battery module (1),
wherein the battery module (1) also has an electrically conductive connecting element (6) that has a first layer (61), formed from a first material, with a first surface (71) and a second surface (72), and a second layer (62), formed from a second material, which is different than the first material, with a first surface (81) and a second surface (82), and
wherein the second surface (72) of the first layer (61) and the second surface (82) of the second layer (62) are electrically conductively and directly connected to one another and the first surface (81) of the second layer (62) is electrically conductively connected to the signal line connection (5), and an electrically conductive conductor track (9) formed from the first material is electrically conductively connected to the cell connector (4) or to the first voltage tap (3) and is also electrically conductively connected to the first surface (71) of the first layer (61).

2. The battery module according to claim 1, characterized in that the first voltage tap (3) and/or the cell connector (4) are formed from the first material and/or in that the signal line connection (5) is formed from a third material, which is different than the first material.

3. The battery module according to claim 1, characterized in that the first material is aluminum and the electrically conductive conductor track (9) is connected by a material bond to the first surface (71) of the first layer (61).

4. The battery module according to claim 1, characterized in that the first material is aluminum and the electrically conductive conductor track (9) is connected by a material bond to the cell connector (4) or the first voltage tap (3).

5. The battery module according to claim 2, characterized in that the second material is copper and in that also the third material is copper, wherein the first surface (81) is connected by a material bond to the signal line connection (5).

6. The battery module according to claim 2, characterized in that the second material is nickel and in that also the third material is copper, wherein the first surface (81) of the second layer (62) is connected by a material bond to the signal line connection (5).

7. The battery module according to claim 1, characterized in that the battery module (1) also has a water-repellant and/or electrically insulating protective layer that at least partially covers from the surroundings at least one connection region, formed circumferentially on the connecting element, between the first layer and the second layer.

8. The battery module according to claim 6, characterized in that solder material forms the protective layer (10).

9. The battery module according to claim 1, characterized in that the signal line connection (5) is configured to be arranged on a printed circuit board of the battery module (1).

10. A cover element of a battery module (1) having a plurality of battery cells (2),
having a cell connector (4) configured for electrically series or parallel connection of two battery cells (2) of the battery module (1) to one another, and the cover element also has a signal line connection (5) connectable to a monitoring unit of the battery module (1),
wherein the cover element also has an electrically conductive connecting element (6) that has a first layer (61), formed from a first material, with a first surface (71) and a second surface (72), and a second layer (62), formed from a second material, which is different than the first material, with a first surface (81) and a second surface (82),
wherein the second surface (72) of the first layer (61) and the second surface (82) of the second layer (62) are electrically conductively and directly connected to one another and the first surface (81) of the first layer (61) is electrically conductively connected to the signal line connection (5), and an electrically conductive conductor track (9) formed from the first material is electrically conductively connected to the cell connector (4) and electrically conductively connected to the first surface (71) of the connecting element (6).

11. A method for manufacturing a battery module or a cover element, the method comprising
a first step of providing a cell connector (4) that is configured for series or parallel connection of a first voltage tap (3) and a second voltage tap (7), a signal line connection (5) configured to be connected to a monitoring unit of the battery module, and an electrically conductive connecting element (6) that has a first layer (61), formed from a first material, with a first surface (71) and a second surface (72), and a second layer (62), formed from a second material, which is different than the first material, with a first surface (81) and a second surface (82), wherein wherein the second surface (72) of the first layer (61) and the second surface (82) of the second layer (62) are electrically conductively and directly connected to one another,
then, in a second step, electrically conductively connecting the first surface (81) of the second layer (62) to the signal line connection (5), and
then, in a third step, electrically conductively connecting an electrically conductive conductor track (9), formed from the first material, to the cell connector (4) or the first voltage tap (3), and electrically conductively connecting the electrically conductive conductor track (9) formed from the first material to the first surface (71) of the first layer (61).

12. The method according to claim 10, characterized in that the first step also comprises forming the electrically conductive connecting element (6), wherein the second surface (72) of the first layer and the second surface (82) of the second layer are electrically conductively and directly connected to one another by a roll-bonding process.

13. The method according to claim 10, characterized in that the signal line connection (5), in the first step, is also arranged on a printed circuit board of the battery module (1), and in that prior to the performance or after the performance of the third step, a protective layer (10) is arranged on the printed circuit board such that at least the connection region formed circumferentially on the connecting element between the first layer (61) and the second layer (62) is covered from the surroundings.

14. The method according to claim 10, characterized in that the third method step involves the electrically conductive conductor track (9) being connected by a material bond to the cell connector (4) or the first voltage tap (3) and also being connected by a material bond to the first surface (71) of the electrically conductive connecting element (6).

15. The method according to claim 10, characterized in that the second step involves the second surface (82) of the second layer being connected by a material bond to the signal line connection (5).

16. A battery having a battery module according to claim 1.

17. A battery having a cover element according to claim 9.

18. The battery module according to claim 1, characterized in that the first material is aluminum and the electrically conductive conductor track (9) is connected by welding to the first surface (71) of the first layer (61).

19. The battery module according to claim 1, characterized in that the first material is aluminum and the electrically conductive conductor track (9) is connected by welding to the cell connector (4) or the first voltage tap (3).

20. The battery module according to claim 2, characterized in that the second material is copper and in that also the third material is copper, wherein the first surface (81) is connected by welding to the signal line connection (5).

21. The battery module according to claim 2, characterized in that the second material is nickel and in that also the third material is copper, wherein the first surface (81) of the second layer (62) is connected by soldering to the signal line connection (5).

22. The cover element according to claim 10, wherein the cell connector (4) is formed from a first material, and signal line connection (5) is formed from a third material, which is different than the first material.

23. The method according to claim 10, characterized in that the third method step involves the electrically conductive conductor track (9) being connected by welding to the cell connector (4) or the first voltage tap (3) and also being connected by welding to the first surface (71) of the electrically conductive connecting element (6).

24. The method according to claim 10, characterized in that the second step involves the second surface (82) of the second layer being connected by welding or soldering to the signal line connection (5).
